(19) United States
(12) Patent Application Publication
(10) Pub. No.: US 2026/0050658 A1
(43) Pub. Date: Feb. 19, 2026

(54) VOICEPRINT RECOGNITION

(71) Applicant: MASHANG CONSUMER FINANCE CO., LTD., Chongqing (CN)

(72) Inventor: Yanli CHEN, Chongqing (CN)

(73) Assignee: MASHANG CONSUMER FINANCE CO., LTD., Chongqing (CN)

(21) Appl. No.: 19/004,445

(22) Filed: Dec. 29, 2024

(30) Foreign Application Priority Data
Aug. 13, 2024 (CN) 202411110893.5

(51) Int. Cl. G06F 21/32; G06N 20/00

(52) U.S. Cl. CPC G06F 21/32; G06N 20/00

(57) ABSTRACT

A voiceprint recognition method includes: obtaining sets of second voiceprint features by, for each of first voiceprint features, determining voiceprint features in a voiceprint library similar to the first voiceprint feature as a set of second voiceprint features; obtaining first correlations for the first voiceprint features by, for every two of the first voiceprint features, determining a correlation between the two first voiceprint features based on a first set of second voiceprint features corresponding to one first voiceprint feature, a number of second voiceprint features of the first set, a second set of second voiceprint features corresponding to the other first voiceprint feature, and a number of second voiceprint features of the second set, as a first correlation; and determining user information for each of the first voiceprint features based on the first correlations and first similarities between the first voiceprint features.

### CROSS-REFERENCE TO RELATED APPLICATION

This application claims priority to and the benefit of Chinese Patent Application No. 202411110893.5, filed on Aug. 13, 2024, the disclosure of which is incorporated herein by reference in its entirety.

### TECHNICAL FIELD

The present disclosure relates to speech processing technologies, and more particularly to voiceprint recognition.

### BACKGROUND

As one of biometric features, voiceprint reflects the user's voice characteristics and may be applied to various business scenarios that require recognition of the user's identity. However, in some business scenarios, there are challenges. For example, in a scenario, there are voiceprint features of multiple unlabeled users and it is necessary to accurately recognize which ones of the voiceprint features belong to the same one of the users.

### SUMMARY

According to some embodiments of the present disclosure, a voiceprint recognition method includes: obtaining a plurality of sets of second voiceprint features respectively corresponding to a plurality of first voiceprint features by, for each of the first voiceprint features, determining ones of voiceprint features in a voiceprint library similar to the each of the first voiceprint features as one of the sets of second voiceprint features; obtaining a plurality of first correlations for the first voiceprint features by, for every two of the first voiceprint features respectively as a first first voiceprint feature and a second first voiceprint feature, determining a correlation between the first first voiceprint feature and the second first voiceprint feature based on a first set of the sets of second voiceprint features corresponding to the first first voiceprint feature, a first number of second voiceprint features of the first set, a second set of the sets of second voiceprint features corresponding to the second first voiceprint feature, and a second number of second voiceprint features of the second set, as one of the first correlations; and determining user information for each of the first voiceprint features based on the first correlations and a plurality of first similarities, each of the first similarities representing a similarity between two of the first voiceprint features.

According to some embodiments of the present disclosure, an electronic device includes: a processor; and a memory storing instructions executable by the processor to perform the above voiceprint recognition method.

According to some embodiments of the present disclosure, a non-transitory computer-readable storage medium storing instructions executable by a processor of an electronic device to perform the above voiceprint recognition method.

According to some embodiments of the present disclosure, a computer program product includes a non-transitory computer-readable storage medium storing a computer program executable by a computer to perform the above voiceprint recognition method.

### BRIEF DESCRIPTION OF THE DRAWINGS

FIG. 1 is a schematic diagram of an example of an implementation environment where a voiceprint recognition method according to some embodiments of the present disclosure can be applied.

FIG. 2 is a schematic flowchart of a voiceprint recognition method according to some embodiments of the present disclosure.

FIG. 3 is a schematic flowchart of a process for determining a set of second voiceprint features according to some embodiments of the present disclosure.

FIG. 4 is a schematic flowchart of a voiceprint recognition method according to some embodiments of the present disclosure.

FIG. 5 is a schematic flowchart of a voiceprint recognition method according to some embodiments of the present disclosure.

FIG. 6 is a schematic block diagram of a voiceprint recognition apparatus according to some embodiments of the present disclosure.

FIG. 7 is a schematic block diagram of an electronic device according to some embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

The terms “first”, “second”, etc. in this specification and claims are used to distinguish similar objects and are not used to describe a particular order or sequence. It should be understood that the data so used may be interchanged, where appropriate, embodiments of the present disclosure can be implemented in an order other than those illustrated or described herein. In addition, “and/or” in this specification and in the claims denotes at least one of the connected objects, and the character “/” generally indicates that the objects associated with each other are in an “or” relationship.

The applicant has studied the voiceprint recognition methods in the related art and found that, on the one hand, in such voiceprint recognition methods, the similarity between two voiceprint features is usually evaluated based on a Euclidean distance between the two voiceprint features or other distance measurement methods applicable to the data type. If the similarity is greater than a certain threshold, the two voiceprint features are determined to belong to the same user, otherwise, they belong to different users. However, these methods only focus on the single indicator, that is, the similarity between different voiceprint features, and the evaluation method is too rough and has the problem of low accuracy.

On the other hand, through analysis, it is found that different voiceprint features of the same user are often highly correlated. With the correlation between two voiceprint features, it is also possible to help recognize to a certain extent whether the two voiceprint features belong to the same user.

On still other hand, through analysis of voiceprint correlation, it is found that if two voiceprint features share more similar voiceprint features in a massive voiceprint library, the greater the correlation between the two voiceprint features, the greater the possibility that the two voiceprint features belong to the same user. Therefore, the correlation between the two voiceprint features may be accurately evaluated by using the similar voiceprint features similar to each voiceprint feature and the number of similar voiceprint features.

Taking into account the above considerations, some embodiments of the present disclosure provide a voiceprint recognition method, which replaces the current technical concept of only focusing on the similarity between different voiceprint features, combines the similarity and the correlation between different voiceprint features, and makes full use of the information complementarity between the similarity and the correlation to recognize the user information for the voiceprint features, thereby improving the accuracy and the robustness of the voiceprint recognition.

It should be understood that the voiceprint recognition method according to some embodiments of the present disclosure may be performed by an electronic device. The electronic devices herein may include terminal devices, such as smart phones, tablet computers, laptop computers, desktop computers, intelligent speech interaction devices, smart home appliances, smart watches, vehicle terminals, aircraft, etc. Alternatively, the electronic devices may include servers, such as independent physical servers, server clusters or distributed systems formed by a plurality of physical servers, or cloud servers that provide cloud computing services.

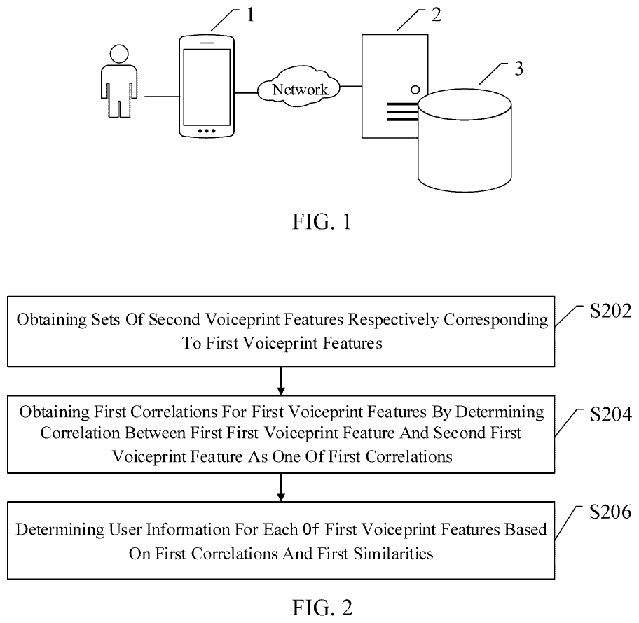

As shown in FIG. 1, an example of an implementation environment where a voiceprint recognition method according to some embodiments of the present disclosure can be applied includes a terminal device 1 and a server 2. The terminal device 1 interacts with the server 2 via a wireless network or a wired network. The terminal device 1 may be a smart phone, a tablet computer, a laptop computer, a desktop computer, an intelligent speech interaction device, a smart home appliance, a smart watch, a vehicle terminal, an aircraft, etc. The server 2 may be an independent physical server, a server cluster or a distributed system formed by a plurality of physical servers, or a cloud server providing cloud computing services. A massive voiceprint library 3 is disposed in the server 2.

In an example, an application supporting speech collection function runs in the terminal device 1. The terminal device 1 may collect the speech input by the user, extract one or more voiceprint features (hereafter referred to be first voiceprint features) from the speech, and store the one or more voiceprint features in a local voiceprint set to be recognized. When voiceprint recognition is required, the terminal device 1 obtains one or more similar voiceprint features (hereafter referred to be second voiceprint features) similar to each voiceprint feature in the voiceprint set to be recognized from the massive voiceprint library 3, and then recognizes which voiceprint features belong to the same user based on the similarity (hereafter referred to be a first similarity) between every two ones of the voiceprint features in the voiceprint set to be recognized and the one or more similar voiceprint features of the massive voiceprint library 3 for the voiceprint feature.

As another example, the terminal device 1 sends the collected speech to the server 2. The server 2 extracts the voiceprint feature from the received speech and stores the one or more voiceprint features in the local voiceprint set to be recognized. When the voiceprint recognition is required, the server 2 obtains one or more similar voiceprint features for each voiceprint feature in the voiceprint set to be recognized from the massive voiceprint library 3, and then identifies which voiceprint features belong to the same user based on the similarity between every two ones of the voiceprint features in the voiceprint set to be recognized and the one or more similar voiceprint features of the massive voiceprint library 3 for the voiceprint features.

Based on the above implementation environment, some embodiments of the present disclosure provide a voiceprint recognition method. FIG. 2 is a schematic flowchart of a voiceprint recognition method according to some embodiments of the present disclosure The method includes Step S202 to Step S206.

At Step S202, a plurality of sets of second voiceprint features respectively corresponding to a plurality of first voiceprint features are obtained by, for each of the first voiceprint features, determining ones of voiceprint features in a voiceprint library similar to the each of the first voiceprint features as one of the sets of second voiceprint features.

The second voiceprint feature may be referred to as one or more nodes of the first voiceprint feature in the voiceprint library adjacent to first voiceprint feature.

At the above Step S202, the second voiceprint features similar to the first voiceprint feature may be determined in various ways, and the present disclosure is not limited herein.

In an implementation, the second voiceprint feature similar to the first voiceprint feature is determined by the following steps: determining a plurality of second similarities respectively corresponding to the voiceprint features in the voiceprint library, where each of the second similarities represents a similarity between the each of the first voiceprint features and one of the voiceprint features in the voiceprint library; and determining ones of the voiceprint features in the voiceprint library each having one of the second similarities in the first n positions as n second voiceprint features similar to the first voiceprint feature. Where n is a positive integer, and the value of n may be set according to actual requirement, and the present disclosure is not limited herein.

In another implementation, in order to accurately evaluate the correlation between different ones of the first voiceprint features by using the second voiceprint features similar to the first voiceprint features, the second voiceprint features similar to the first voiceprint feature are determined by the following steps. determining a plurality of second similarities respectively corresponding to the voiceprint features in the voiceprint library, where each of the second similarities represents a similarity between the each of the first voiceprint features and one of the voiceprint features in the voiceprint library; determining ones of the voiceprint features in the voiceprint library each having one of the second similarities greater than or equal to a first preset similarity threshold, as a plurality of candidate voiceprint features; and determining, from the candidate voiceprint features, the ones of the voiceprint features in the voiceprint library similar to the each of the first voiceprint features as the one of the sets of second voiceprint features.

In an example, after obtaining the candidate voiceprint feature, the candidate voiceprint feature may be used as the second voiceprint feature similar to the first voiceprint feature at the determining of the ones of the voiceprint features in the voiceprint library similar to the each of the first voiceprint features as the one of the sets of second voiceprint features from the candidate voiceprint features.

In another example, the determining of the ones of the voiceprint features in the voiceprint library similar to the each of the first voiceprint features as the one of the sets of second voiceprint features from the candidate voiceprint features includes the first substep to the third substep. At the first substep, a plurality of third similarities for the candidate voiceprint features are determined and each of the third similarities represents a similarity between every two of the candidate voiceprint features. At the second substep, a density coefficient for each first voiceprint feature is determined based on the third similarities and ones of the second similarities respectively corresponding to the candidate voiceprint features. At the third substep, in response determining that the density coefficient is greater than or equal to a preset coefficient threshold, the candidate voiceprint features are determined as the one of the sets of second voiceprint features.

The density coefficient for the first voiceprint feature is used to indicate the probability that the first voiceprint feature and the candidate voiceprint feature belong to the same user, that is, the possibility that the first voiceprint feature and the candidate voiceprint feature belong to the same user. The greater the density coefficient, the higher the correlations between the first voiceprint feature and the candidate voiceprint feature and between the candidate voiceprint features, and the greater the possibility that the candidate voiceprint feature and the first voiceprint feature belong to the same user.

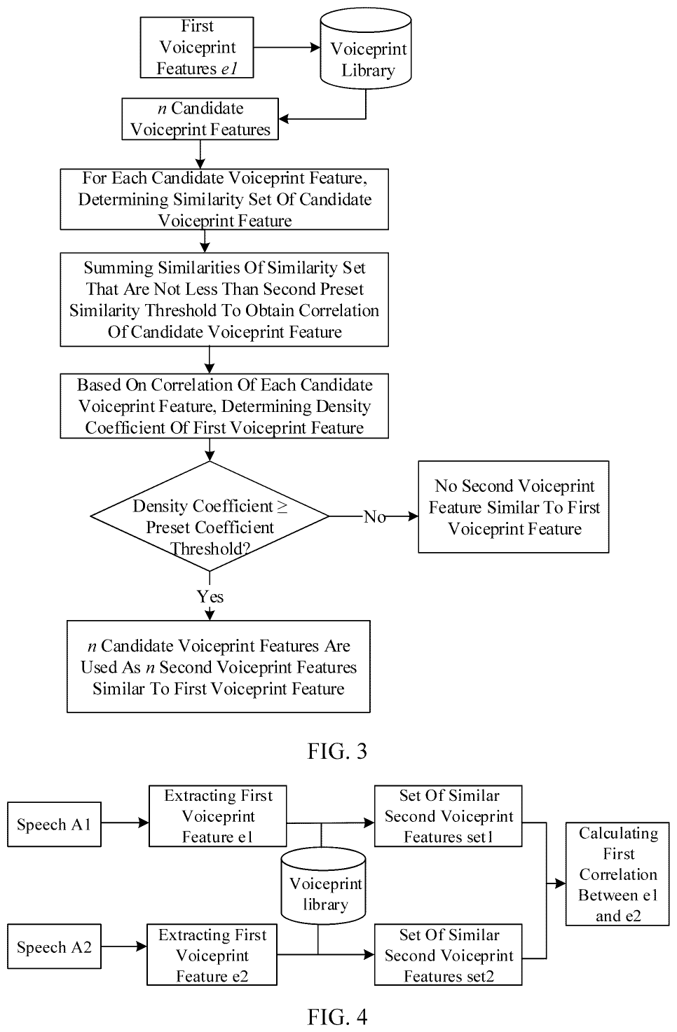

At the second substep, the number of the candidate voiceprint features is more than one. As shown in FIG. 3, the density coefficient for the first voiceprint feature may be determined in the following manner: obtaining a plurality of second correlations respectively corresponding to the candidate voiceprint features by, for each of the candidate voiceprint features, taking one of the second similarities corresponding to the each of the candidate voiceprint features and ones of the third similarities associated with the each of the candidate voiceprint features as a set of similarities and calculating a sum of ones in the set of similarities each being greater than or equal to a second preset similarity threshold as one of the second correlations; and determining the density coefficient for the each of the first voiceprint features based on the second correlations.

For each candidate voiceprint feature, the correlation for the candidate voiceprint feature represents the correlations between the candidate voiceprint feature and the first voiceprint feature and between the candidate voiceprint feature and other candidate voiceprint features.

More specifically, in an example, after obtaining the correlation for each candidate voiceprint feature, the average of the correlations for all the one or more candidate voiceprint features may be used as the density coefficient.

In another example, the sum of the second correlations is determined, and a logarithmic operation is performed on the sum of the second correlations to obtain the density coefficient for the each of the first voiceprint features.

At the third substep, as shown in FIG. 3, the number of the candidate voiceprint features is n. In the case that the density coefficient is not less than the preset coefficient threshold, the n candidate voiceprint features are used as the n second voiceprint features similar to the first voiceprint feature. By using the n candidate voiceprint features which are different voiceprint features closely associated with each other, the first correlation between different voiceprint features may be accurately evaluated, thereby more accurately recognizing which voiceprint features belong to the same user. Otherwise, the n candidate voiceprint features are discarded, that is, there is no second voiceprint feature similar to the first voiceprint feature in the voiceprint library.

For example, the n candidate voiceprint features for the first voiceprint feature e₁ are recorded as e₁₁, e₁₂, . . . , e₁ₙ. Taking the candidate voiceprint feature e₁₁ as an example, the second similarity between the first voiceprint feature e₁ and the candidate voiceprint feature e₁₁ is recorded as Sₑ₁₁ₑ₁, and the third similarities between the candidate voiceprint feature e₁₁ and respective ones of the remaining (n−1) candidate voiceprint features are recorded as Sₑ₁₁ₑ₁₂, . . . , Sₑ₁₁ₑ₁ₙ. Then the neighbor correlation for the candidate voiceprint feature e₁₁ may be determined by the following formula (1). Further, the sum of the neighbor correlations for the n candidate voiceprint features may be determined by the following formula (2). Further, the density coefficient for the first voiceprint feature may be determined by the following formula (3). Further, in response determining that the density coefficient is greater than or equal to the preset coefficient threshold, it is determined that the second voiceprint feature similar to the first voiceprint feature e₁ includes {e₁₁, e₁₂, . . . , e₁ₙ}. Otherwise, it is determined that there is no second voiceprint feature similar to the first voiceprint feature.

$${w}_{link 11} = sum ( {S}_{e 11 e 1} , {S}_{e 11 e 12} , … , {S}_{e 11 e 1 n} ) if S \geq {thr}_{s} \qquad ( 1 )$$

$$E = {\sum }_{1}^{n} {w}_{link 1 i} \qquad ( 2 )$$

$$α = {log}_{n} E \qquad ( 3 )$$

Therein, wₗᵢₙₖ₁₁ represents the neighbor correlation for the candidate voiceprint feature e₁₁; Sₑ₁₁ₑ₁, Sₑ₁₁ₑ₁₂, . . . , Sₑ₁₁ₑ₁ₙ represents the similarities in the similarity set S of the candidate voiceprint feature e₁₁; thrₛ represents the second preset similarity threshold which may be set, for example, to 0.7, according to actual requirement; if S≥thrₛ means “if the second/third similarity is greater than or equal to thrₛ”; E represents the sum of the neighbor correlations for the n candidate voiceprint features e₁₁, e₁₂, . . . , e₁ₙ; and α represents the density coefficient for the first voiceprint feature e₁.

In the above implementation, for each first voiceprint feature, after the candidate voiceprint features similar to the first voiceprint feature are initially searched from the voiceprint library, the searched result is not directly returned, but the density coefficient for the first voiceprint feature is evaluated based on the third similarities between the candidate voiceprint features and the second similarities between respective ones of the candidate voiceprint feature and the first voiceprint feature and it is determined whether to these candidate voiceprint features is used as the second voiceprint features similar to the first voiceprint feature based on the density coefficient. Since the density coefficient may reflect the possibility that the first voiceprint feature and the plurality of candidate voiceprint features belong to the same user. The greater the density coefficient, the stronger the correlation between these voiceprint features, and the greater the possibility of belonging to the same user. In response determining that the density coefficient is not less than the preset coefficient threshold, these candidate voiceprint features are used as the second voiceprint features similar to the first voiceprint feature. Otherwise a null value is returned. Therefore, the first preset similarity threshold used for searching in the voiceprint library is effectively balanced, the first preset similarity threshold is avoided from being too strict to cause a large number of missed searches, and the first preset similarity threshold is avoided from being too loose to cause inaccurate subsequent processing results based on the searched results. In this way, the accuracy of the searched results is further improved, and reliable data support is provided for subsequent voiceprint recognition.

The above embodiments of the present disclosure illustrate some implementation methods of the above Step S202. However, it should be understood that the above Step S202 may be implemented in other ways, and the present disclosure is not limited herein.

At Step S204, a plurality of first correlations for the first voiceprint features are obtained by, for every two of the first voiceprint features respectively as a first first voiceprint feature and a second first voiceprint feature, determining a correlation between the first first voiceprint feature and the second first voiceprint feature based on a first set of the sets of second voiceprint features corresponding to the first first voiceprint feature, a first number of second voiceprint features of the first set, a second set of the sets of second voiceprint features corresponding to the second first voiceprint feature, and a second number of second voiceprint features of the second set, as one of the first correlations.

Through voiceprint correlation analysis, it is found that the more similar voiceprint features two voiceprint features share in the massive voiceprint library, the greater the correlation between the two voiceprint features. Therefore, the correlation between the two voiceprint features may be accurately evaluated by using the similar voiceprint features of the two voiceprint features in the massive voiceprint library.

In an implementation, the above Step S204 may include the following steps: determining an intersection of the first set and the second set; and determining the correlation between the first first voiceprint feature and the second first voiceprint feature based on a number of second voiceprint features of the intersection, the first number and the second number.

In an example, at the determining of the intersection of the first set and the second set, the first correlation may be determined by the following formula (4):

$$ε = \vert set 1 ⋂ set 2 \vert / \sqrt{\vert set 1 \vert * \vert set 2 \vert} \qquad ( 4 )$$

where ε represents the first correlation between two first voiceprint features, and ε∈[0,1]; set1 represents a first set of the second voiceprint features similar to one of the two first voiceprint features, and |set1| represents the number of the second voiceprint features of set1; set2 represents a second set of the second voiceprint features similar to the other of the two first voiceprint features, and |set2| represents the number of the second voiceprint features of set2; and set1∩set2 represents the intersection of set1 and set2, and |set1∩set2| represents the number of the second voiceprint features in the intersection.

For example, as shown in FIG. 4, assume that the first voiceprint feature e₁ is extracted from speech A1 and the first voiceprint feature e₁ is extracted from speech A2, the set of the second voiceprint features similar to the first voiceprint feature e₁ is determined from the voiceprint library as set1, and the set of the second voiceprint features similar to the first voiceprint feature e₂ is determined from the voiceprint library as set2. Further, based on the intersection of set1 and set2, the first similarity between the first voiceprint feature e₁ and the first voiceprint feature e₂ may be accurately evaluated.

At Step S206, user information for each of the first voiceprint features is determined based on the first correlations and a plurality of first similarities, where each of the first similarities represents a similarity between two of the first voiceprint features.

The user information for the first voiceprint feature is used to describe the user to which the first voiceprint feature belongs. Exemplarily, the user information for the first voiceprint feature may describe the class of the user to which the first voiceprint feature belongs. In the case where there are a plurality of first voiceprint features, each first voiceprint feature has user information corresponding to the first voiceprint feature to indicate the class of the user to which the first voiceprint feature belongs.

In an embodiment of the present disclosure, there are a plurality of first voiceprint features. The first voiceprint features are extracted from the speech. Different first voiceprint features may be extracted from different speech, or different first voiceprint features may be extracted from different speech segments of the same speech. Extracting the first voiceprint features from the speech may be achieved by various feature extraction methods, such as through a pre-trained voiceprint feature extraction model. During the extraction process, the dimension of the first voiceprint feature may be set according to actual requirement, and the commonly used dimension includes but is not limited to: 192, 256, 512, etc.

The first similarity between any two first voiceprint features may be determined by using various distance measurement methods applicable to the data type, such as the cosine distance, the Euclidean distance, etc., which is not limited in this embodiment of the present disclosure.

In an embodiment, the first similarity between any two first voiceprint features is determined by calculating the cosine distance between any two first voiceprint features as the first similarity between the two first voiceprint features, that is, s=cos(e₁, e₂), where s represents the cosine distance, s∈[−1,1], e₁ and e₂ represent the two first voiceprint features.

The recognition result is used to indicate which first voiceprint features among the plurality of first voiceprint features mentioned above belong to the same user.

In an embodiment, the above Step S206 includes first to third operations.

At the first operation, the every two of the first voiceprint features respectively are taken as the first first voiceprint feature and the second first voiceprint feature.

For example, assuming there are the first voiceprint features e1 and e2, the first first voiceprint feature e1 and the second first voiceprint feature e2 are combined to obtain a voiceprint pair.

For another example, assuming there are first voiceprint features e1 to e4, every two of the first voiceprint features are combined in pair, to obtain six voiceprint pairs: e1 and e2, e1 and e3, e1 and e4, e2 and e3, e2 and e4, e3 and e4.

At the second operation, the first first voiceprint feature and the second first voiceprint feature are labeled with a first label based on the one of the first correlations and one of the first similarities representing the similarity between the first first voiceprint feature and the second first voiceprint feature, where the first label indicates whether the first first voiceprint feature and the second first voiceprint feature belong to a same user.

In an example, for each voiceprint pair, in response determining that the first similarity between the first voiceprint features of the voiceprint pair is greater than the third preset similarity threshold and the first correlation between the first voiceprint features of the voiceprint pair is greater than the first preset correlation threshold, it is determined that the first voiceprint features of the voiceprint pair belong to the same user, and then the first voiceprint features of the voiceprint pair is labeled with a first label “1”. Otherwise, it is determined that the first voiceprint features of the voiceprint pair respectively belong to different users, and then the first voiceprint features of the voiceprint pair is labeled with a first label “0”.

In another example, for each voiceprint pair, the product of the first similarity and the first correlation between the first voiceprint features of the voiceprint pair is determined. If the product is greater than a preset value, it is determined that the first voiceprint features of the voiceprint pair belong to the same user, and then the two first voiceprint features are labeled with the first label “1”. Otherwise, it is determined that the two first voiceprint features belong to different users, and then the two first voiceprint features are labeled with the first label “0”. The preset value of the first label may be set according to actual requirement, such as a value in a range of [−1, 1].

In another example, in order to make the voiceprint recognition results better adapt to the security requirements of downstream businesses, in the second operation, the voiceprint pair (i.e., the first label based on a security level for the first first voiceprint feature and the second first voiceprint feature) is labeled with the first label based on a security level for the first first voiceprint feature and the second first voiceprint feature, the one of the first correlations and the one of the first similarities.

The security level is positively correlated with the security identification requirements for the first voiceprint feature.

For example, in response determining that the security identification requirement for the first voiceprint feature is higher, such as a higher requirement for the false rejection rate but a lower requirement for the false acceptance rate, the security level of the first voiceprint feature is higher, and the classification condition is that: the first similarity is greater than the third preset similarity threshold, and the first correlation is greater than the first preset correlation threshold. In this case, if the first similarity and the first correlation between the first voiceprint features in the voiceprint pair meet the classification condition, the voiceprint pair is labeled with the first label “1” to indicate that the first voiceprint features in the voiceprint pair belongs to the same user. Otherwise, the voiceprint pair is labeled with the first label “0” to indicate that the first voiceprint features in the voiceprint pair does not belong to the same user.

In response determining that the security identification requirement for the first voiceprint feature is lower, for example, the lower requirement for the false rejection rate but the higher requirement for the false acceptance rate, the security level of the first voiceprint feature is lower, and the classification condition is that: the first similarity is greater than the third preset similarity threshold, or the first correlation is greater than the first preset correlation threshold. In this case, if the first similarity and the first correlation between the first voiceprint features in the voiceprint pair meet the classification condition, the voiceprint pair is labeled with the first label “1” to indicate that the first voiceprint features in the voiceprint pair belongs to the same user. Otherwise, the first voiceprint features in the voiceprint pair is labeled with the first label “0” to indicate that the first voiceprint features in the voiceprint pair does not belong to the same user.

At the third operation, user information for each of the first first voiceprint feature and the second first voiceprint feature is determined based on the first label of the voiceprint pair.

For example, assuming that there are first voiceprint features e1 to e4, the first labels of the six voiceprint pairs are determined through the first to second operations as follows:

| | |
|---|---|
| Voiceprint pair 1: e1 and e2 | First label: 0 |
| Voiceprint pair 2: e1 and e3 | First label: 0 |
| Voiceprint pair 3: e1 and e4 | First label: 1 |
| Voiceprint pair 4: e2 and e3 | First label: 1 |
| Voiceprint pair 5: e2 and e4 | First label: 0 |
| Voiceprint pair 6: e3 and e4 | First label: 0 |

Therefore, the user information for each of the above first voiceprint features may be determined as follows: the first voiceprint features e1 and e4 belong to the same user, and the first voiceprint features e2 and e3 belong to the same user.

In the above implementation, by combining the similarity and the correlation between different voiceprint features and making full use of the information complementarity between the similarity and the correlation, it is possible to recognize whether different voiceprint features belong to the same user, thereby improving the accuracy and the robustness of voiceprint recognition.

It should be noted that the above implementation is applicable to the situation where the number of the plurality of first voiceprint features described above is less. In this way, the user information for the plurality of first voiceprint features may be quickly determined without multi-time combinations and comparisons.

In another implementation, the above Step S206 includes a fourth operation to a fifth operation.

At the fourth operation, the first voiceprint features are clustered based on the first similarities and the first correlations to obtain, for each of the first voiceprint features, a cluster to which each first voiceprint feature belongs.

The clustering of the plurality of first voiceprint features refers to clustering the first voiceprint features belonging to the same user into a cluster, to obtain at least one cluster, and each cluster includes at least one first voiceprint feature.

In an example, for each first voiceprint feature, the first voiceprint feature may be clustered into a cluster with other first voiceprint features whose first similarity is greater than a fourth preset similarity threshold, and the first voiceprint features in the same cluster may be labeled with the same second label. Then, the unlabeled first voiceprint features may be clustered by using the labeled first voiceprint features, to label the unlabeled first voiceprint features with the second labels.

Considering that the clustering accuracy of the first example above is affected by the fourth preset similarity threshold, the condition that the fourth preset similarity threshold is too high, to cause inter-class errors. The fourth preset similarity threshold is too low, to cause excessive intra-class noise. These will lead to inaccurate clustering results, causing the first voiceprint features belonging to different users to be clustered together, to affect the accuracy of voiceprint recognition.

In view of this, in another example, the fourth operation includes: performing a plurality of labeling operations on the first voiceprint features, respectively, to generate second labels respectively for the first voiceprint features; and obtaining the cluster to which the each of the first voiceprint features belongs by aggregating ones of the first voiceprint features, for which respective ones of the second labels are identical, into a cluster.

Each of the plurality of labeling operations includes: the first sub-operation of selecting an unlabeled one of the first voiceprint features as a target first voiceprint feature; the second sub-operation of determining one or more of the first voiceprint features similar to the target first voiceprint feature based on the first similarities, as one or more third first voiceprint features; the third sub-operation of determining a cluster center type for the target first voiceprint feature based on ones of the first correlations each representing a correlation between one of the third first voiceprint features and the target first voiceprint feature; and the fourth sub-operation of labeling, based on the cluster center type, the target first voiceprint feature and each unlabeled one of the third first voiceprint features with one of the second labels.

For each of the plurality of labeling operations, at the first sub-operation, the unlabeled first voiceprint feature is randomly selected.

At the second sub-operation, a first voiceprint feature of the above first voiceprint features, having a first similarity between the first voiceprint feature and the target first voiceprint feature that is greater than or equal to the fourth preset similarity threshold, is used as the third first voiceprint feature similar to the target first voiceprint feature.

At the third sub-operation, one or more of the third first voiceprint features are determined as one or more target third first voiceprint features, where one of the first correlations between each of the one or more of the third first voiceprint features and the target first voiceprint feature is greater than a preset correlation threshold; and in response to determining that a number of the target third first voiceprint features is greater than or equal to a preset number threshold, the cluster center type is determined to be a type of valid cluster center. Otherwise, the cluster center type is determined to be a type of an invalid cluster center.

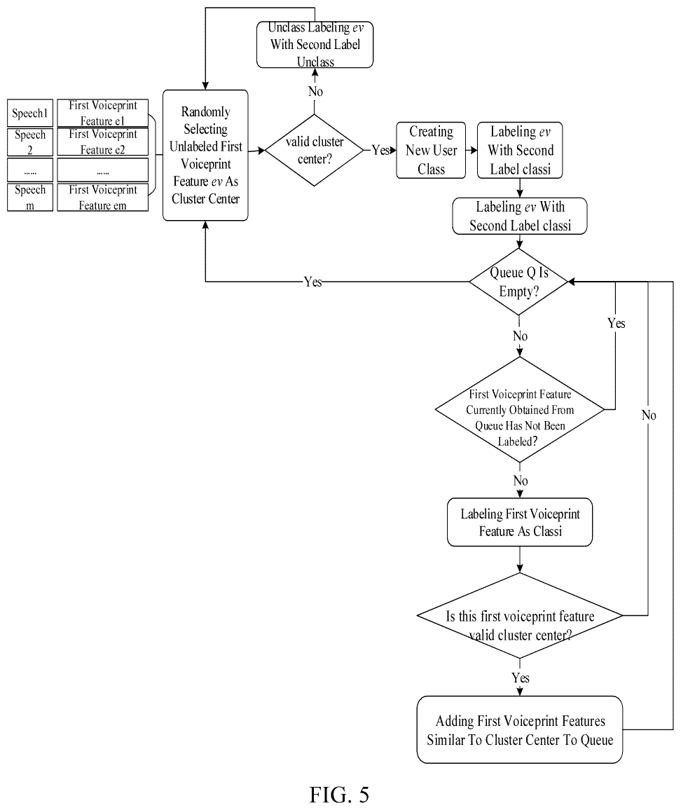

For example, as shown in FIG. 5, in the i-th labeling operation, it is assumed that voiceprint features are extracted from m speeches, respectively, to obtain m first voiceprint features. Then, an unlabeled first voiceprint feature ev is randomly selected from the m first voiceprint features as the target first voiceprint feature. It is assumed that the first voiceprint features (i.e., the third first voiceprint features) similar to the target first voiceprint feature include {e1, e2, e3, e4, e5} and the first correlation between the first voiceprint features e1 to e3 and the first voiceprint feature ev is greater than the preset correlation threshold, it is determined that the first voiceprint feature (i.e., the target third first voiceprint feature) related to the target first voiceprint feature includes {e1, e2, e3}. In response determining that the preset number threshold is three, the number of the first voiceprint features related to the target first voiceprint feature reaches the preset number threshold, and then the cluster center type is determined to be the type of the valid cluster center. In response determining that the preset number threshold is four, the number of the first voiceprint features related to the cluster center does not reach the preset number threshold, and then the cluster center type is determined to be the type of the invalid cluster center.

At the third sub-operation, in response to determining that the cluster center type is a type of valid cluster center, a new user class is created; the target first voiceprint feature is labeled with one of the second labels representing the new user class; and the each unlabeled one of the third first voiceprint features is labeled with the one of the second labels representing the new user class.

For example, as shown in FIG. 5, in the i-th labeling operation, in response determining that the cluster center type is determined to be the type of the valid cluster center, a new user class is created, and the target first voiceprint feature ev is labeled with the second label classi representing the user class. In response determining that the cluster center type is determined to be the type of the invalid cluster center, the target first voiceprint feature ev is labeled with the second label representing the invalid cluster center, such as unclassed, and the next labeling operation is performed.

Then, the first voiceprint feature (i.e., the target third first voiceprint feature) {e1, e2, e3} related to the target first cluster center is added to a queue Q, and the queue Q is consumed to sequentially obtain the first voiceprint feature. In response determining that the first voiceprint feature currently obtained has been labeled, the queue Q continues to be consumed until the queue Q is empty φ. In response determining that the first voiceprint feature currently obtained has not been labeled, the first voiceprint feature is labeled with the same second label classi. Further, based on the above method, the cluster center type of the first voiceprint feature is continued to be determined. In response determining that the cluster center type is the type of the invalid cluster center, the queue Q continues to be consumed as empty φ. In response determining that the cluster center type is the type of the valid cluster center, based on the above method, the first voiceprint feature that is similar to the cluster center and unlabeled is labeled with the same second label classi.

The above method is used to perform multi-times labeling operations on the m first voiceprint features until all the m first voiceprint features are labeled. Further, the first voiceprint features with the same second label are clustered into a cluster, that is, the clustering of the m first voiceprint features is completed, and the plurality of clusters are obtained. Each cluster includes at least one first voiceprint feature clustered together. For example, the following plurality of clusters are obtained:
class 1: {ev,e1,e2,e3}
class2: {e4, e5, . . . , e6}
. . .
unclassed: {e8, e9, . . . , ej}

At the fifth operation, the user information for the each of the first voiceprint features is determined based on the cluster to which the each of the first voiceprint features belongs.

The clustering result includes the plurality of clusters. Based on this, it is determined that the first voiceprint features in the same cluster belong to the same user.

Through the above implementation, a plurality of first voiceprint features are clustered, and each first voiceprint feature only needs to be accessed once to determine the user class. This is not only fast and efficient, but also may reduce the problems of inter-class errors and excessive intra-class noise caused by simple clustering based on thresholds, to improve clustering accuracy, and to improve the accuracy of voiceprint recognition.

An embodiment of the present disclosure provides some implementation methods of the above Step S206. It should be understood that the above Step S206 may be implemented in other ways.

The voiceprint recognition method according to one or more embodiments of the present disclosure takes into account that different voiceprint features of the same user are not only highly similar, but often also highly correlated. The similarity and the correlation between different voiceprint features are combined, and the information complementarity between the similarity and the correlation is fully utilized to recognize whether different voiceprint features belong to the same user, thereby improving the accuracy and the robustness of voiceprint recognition. In addition, considering that the more similar voiceprint features two voiceprint features share, the greater the correlation between the two voiceprint features, and the greater the possibility that the two voiceprint features belong to the same user. Based on this, the correlation between the first voiceprint features is determined by using the second voiceprint features similar to each first voiceprint feature and the number of second voiceprint features, so that the correlation obtained is more accurate, thereby further improving the accuracy of voiceprint recognition.

The above is a description of a specific embodiment of the specification. Other embodiments are within the scope of the appended claims. In some cases, the operations or steps recited in claims may be performed in an order different from that in the embodiments and still achieve the desired results. In addition, the processes depicted in the drawings do not necessarily require the specific order or continuous order shown to achieve the desired results. In some embodiments, multitasking and parallel processing are also possible or may be advantageous.

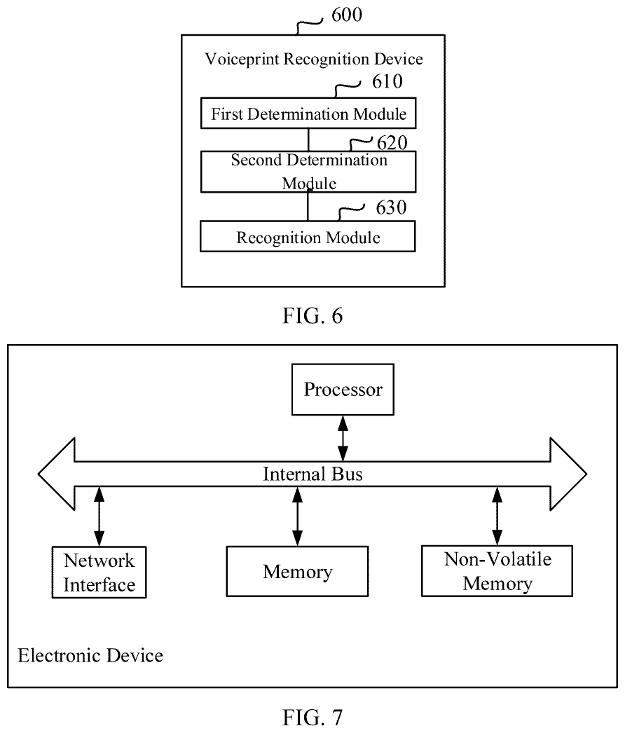

Based on the same inventive concept, the present disclosure also provides a voiceprint recognition device. FIG. 6 is a schematic block diagram of a voiceprint recognition device 600 according to some embodiments of the present disclosure. The voiceprint recognition device 600 includes a first determination module 610, a second determination module 620, and a recognition module 630.

The first determination module 610 is configured to obtain a plurality of sets of second voiceprint features respectively corresponding to a plurality of first voiceprint features by, for each of the first voiceprint features, determining ones of voiceprint features in a voiceprint library similar to the each of the first voiceprint features as one of the sets of second voiceprint features.

The second determination module 620 is configured to obtain a plurality of first correlations for the first voiceprint features by, for every two of the first voiceprint features respectively as a first first voiceprint feature and a second first voiceprint feature, determining a correlation between the first first voiceprint feature and the second first voiceprint feature based on a first set of the sets of second voiceprint features corresponding to the first first voiceprint feature, a first number of second voiceprint features of the first set, a second set of the sets of second voiceprint features corresponding to the second first voiceprint feature, and a second number of second voiceprint features of the second set, as one of the first correlations.

The identification module 630 is configured to determining user information for each of the first voiceprint features based on the first correlations and a plurality of first similarities, and each of the first similarities represents a similarity between two of the first voiceprint features.

In another embodiment, the first determination module is configured to: determine a plurality of second similarities respectively corresponding to the voiceprint features in the voiceprint library, and each of the second similarities represents a similarity between the each of the first voiceprint features and one of the voiceprint features in the voiceprint library; determine ones of the voiceprint features in the voiceprint library each having one of the second similarities greater than or equal to a first preset similarity threshold, as a plurality of candidate voiceprint features; and determine, from the candidate voiceprint features, the ones of the voiceprint features in the voiceprint library similar to the each of the first voiceprint features as the one of the sets of second voiceprint features.

In another embodiment, when the first determination module determines the ones of the voiceprint features in the voiceprint library similar to the each of the first voiceprint features as the one of the sets of second voiceprint features, the first determination module performs the following steps: determining a plurality of third similarities for the candidate voiceprint features, where each of the third similarities represents a similarity between every two of the candidate voiceprint features; determining a density coefficient for the each of the first voiceprint features based on the third similarities and ones of the second similarities respectively corresponding to the candidate voiceprint features, where the density coefficient represents a probability that the each of the first voiceprint features and the candidate voiceprint features belong to a same user; and in response determining that the density coefficient is greater than or equal to a preset coefficient threshold, determining the candidate voiceprint features as the one of the sets of second voiceprint features.

In another embodiment, the number of the candidate voiceprint features is more than one; the first determination module determines the density coefficient for the first voiceprint feature based on the second similarities between the first voiceprint feature and respective ones of the candidate voiceprint features and the third similarity, the first determination module performs the following steps: obtaining a plurality of second correlations respectively corresponding to the candidate voiceprint features by, for each of the candidate voiceprint features, taking one of the second similarities corresponding to the each of the candidate voiceprint features and ones of the third similarities associated with the each of the candidate voiceprint features as a set of similarities and calculating a sum of ones in the set of similarities each being greater than or equal to a second preset similarity threshold as one of the second correlations; and determining the density coefficient for the each of the first voiceprint features based on the second correlations.

In another embodiment, when the first determination module determines the density coefficient for the first voiceprint feature based on the second correlation for each of the one or more candidate voiceprint features, the first determination module performs the following steps: calculating a sum of the second correlations; and performing a logarithmic operation on the sum of the second correlations to obtain the density coefficient for the each of the first voiceprint features.

In another embodiment, the second determination module is configured for: determining an intersection of the first set and the second set; and determining the correlation between the first first voiceprint feature and the second first voiceprint feature based on a number of second voiceprint features of the intersection, the first number and the second number.

In another embodiment, the recognition module is configured for: labeling the first first voiceprint feature and the second first voiceprint feature with a first label; based on the one of the first correlations and one of the first similarities representing the similarity between the first first voiceprint feature and the second first voiceprint feature, where the first label indicates whether the first first voiceprint feature and the second first voiceprint feature belong to a same user; and determining the user information for each of the first first voiceprint feature and the second first voiceprint feature based on the first label.

In another embodiment, when labeling the first first voiceprint feature and the second first voiceprint feature with a first label corresponding to the voiceprint pair based on the first similarity and the first correlation between the first voiceprint features in the voiceprint pair, the recognition module performs the following steps: labeling the first first voiceprint feature and the second first voiceprint feature with the first label based on a security level for the first first voiceprint feature and the second first voiceprint feature, the one of the first correlations and the one of the first similarities.

In another embodiment, the number of the first voiceprint features is more than one.

The identification module is configured for: clustering the first voiceprint features based on the first similarities and the first correlations to obtain, for each of the first voiceprint features, a cluster to which the each of the first voiceprint features belongs; and determining the user information for the each of the first voiceprint features based on the cluster to which the each of the first voiceprint features belongs.

In another embodiment, when the recognition module clusters the plurality of first voiceprint features based on the plurality of first similarities and the plurality of first correlations to obtain the cluster to which each first voiceprint feature belongs, the recognition module performs the following steps: performing a plurality of labeling operations on the first voiceprint features to generate second labels respectively for the first voiceprint features; and obtaining the cluster to which the each of the first voiceprint features belongs by aggregating ones of the first voiceprint features, for which respective ones of the second labels are identical, into a cluster;

Each of the plurality of labeling operations includes: selecting an unlabeled one of the first voiceprint features as a target first voiceprint feature; determining one or more of the first voiceprint features similar to the target first voiceprint feature based on the first similarities, as one or more third first voiceprint features; determining a cluster center type for the target first voiceprint feature based on ones of the first correlations each representing a correlation between one of the third first voiceprint features and the target first voiceprint feature; and labeling, based on the cluster center type, the target first voiceprint feature and each unlabeled one of the third first voiceprint features with one of the second labels.

In another embodiment, when determining the cluster center type for the target first voiceprint feature based on the first correlation between each of the fifth voiceprint features and the target first voiceprint feature, the recognition module performs the following steps: determining one or more of the third first voiceprint features as one or more target third first voiceprint features, where one of the first correlations between each of the one or more of the third first voiceprint features and the target first voiceprint feature is greater than a preset correlation threshold; and in response determining that a number of the target third first voiceprint features is greater than or equal to a preset number threshold, determining the cluster center type to be a type of valid cluster center.

In another embodiment, when labeling each of the target first voiceprint features and the unlabeled one of the fifth voiceprint features with the second label based on the cluster center type, the recognition module performs the following steps: in response to determining that the cluster center type is a type of valid cluster center, creating a new user class; labeling the target first voiceprint feature with one of the second labels representing the new user class; and labeling the each unlabeled one of the third first voiceprint features with the one of the second labels representing the new user class.

Therefore, the voiceprint recognition device 600 according to some embodiments of the present disclosure may be used as an execution subject for the voiceprint recognition method shown in FIG. 2, to realize the function realized by the voiceprint recognition device in FIG. 2. Since the principles of them are same as each other, the detailed description will not be repeatedly provided.

FIG. 7 is a schematic block diagram of an electronic device according to some embodiments of the present disclosure. With reference to FIG. 7, at the hardware level, the electronic device includes a processor, and optionally further includes an internal bus, a network interface, and a memory. The memory may include a memory, such as a high-speed random access memory (RAM), and may further include a non-volatile memory, such as at least one disk storage, etc. The electronic device may further include hardware required for other services.

The processor, the network interface and the memory may be interconnected via an internal bus, which may be an ISA (Industry Standard Architecture) bus, a PCI (Peripheral Component Interconnect) bus or an EISA (Extended Industry Standard Architecture) bus, etc. The bus may be divided into an address bus, a data bus, a control bus, etc. For case of representation, the bus is shown by only using one bidirectional arrow as shown in FIG. 7, which does not mean that there is only one bus or one type of bus.

The memory is configured to store the program. For example, the program may include a program code, and the program code includes a computer operation instruction. The memory may include a memory and a non-volatile memory, and provides instructions and data to the processor.

The processor reads the corresponding computer program from the non-volatile memory into the memory and then runs it, to form a voiceprint recognition device at the logical level. The processor executes the program stored in the memory and is specifically configured to perform the following operations: determining one or more second voiceprint features in a voiceprint library similar to each of one or more first voiceprint features; determining a first correlation between the first voiceprint features based on the second voiceprint features and the number of the second voiceprint features; and determining a first correlation between every two of the first voiceprint features based on the second voiceprint features and a number of the second voiceprint features.

The method performed by the voiceprint recognition device disclosed in the embodiment shown in FIG. 2 of the present disclosure may be applied to a processor or implemented by a processor. The processor may be an integrated circuit chip having signal processing capabilities. In an implementation, the steps of the above method may be performed by integrated logic circuits of hardware in the processor or by instructions in the form of software. The processor may be a general-purpose processor, including a central processing unit (CPU), a network processor (NP), and/or the like. It may also be a digital signal processor (DSP), an application specific integrated circuit (ASIC), a field-programmable gate array (FPGA) or other programmable logic device, a discrete gate or transistor logic device, a discrete hardware component. The methods, steps, and, logical block diagrams disclosed in the embodiments of the present disclosure may be implemented or performed. The general purpose processor may be a microprocessor or the processor may be any conventional processor or the like. The steps of the method disclosed in connection with the embodiment of the present disclosure may be directly performed by a hardware decoding processor, or performed by a combination of hardware and software modules in the decoding processor. The software module may be located in a storage medium mature in the art such as a random access memory, a flash memory, a read-only memory, a programmable read-only memory or an electrically erasable programmable memory, a register, or the like. The storage medium is located in a storage device, and the processor reads information in the storage device and performs the steps of the above method in conjunction with its hardware.

The electronic device may also execute the method of FIG. 2 and implement the functions of the voiceprint recognition device in the embodiments shown in FIG. 2 to FIG. 5. Details of the embodiments of the present disclosure are not redundantly described herein.

In addition to software implementation methods, the electronic device according to some embodiments of the present disclosure does not exclude other implementation methods, such as logic devices or a combination of software and hardware, etc. That is, the execution subject of the following processing flow is not limited to respective ones of the logic units, but it may further include hardware or logic devices.

Some embodiments of the present disclosure further provide a non-transitory computer-readable storage medium, which stores one or more programs, where the one or more programs include instructions, which, when executed by a portable electronic device including a plurality of disclosure programs, enable the portable electronic device to execute the method of the embodiment shown in FIG. 2, and are specifically used to perform the following operations:
determining one or more second voiceprint features similar to each of one or more first voiceprint features;
determining a first correlation between every two of the first voiceprint features based on the second voiceprint features and a number of the second voiceprint features; and
determining user information for each of the first voiceprint features based on the first correlation and the first similarity between every two of the first voiceprint features.

Some embodiments of the present disclosure provide a computer program product, which includes a non-transitory computer-readable storage medium storing a computer program, and the computer program is operable to enable a computer to perform some or all of the steps in the voiceprint recognition method according to some embodiments of the present disclosure.

In sum, the foregoing description is only some embodiments of the present disclosure and is not intended to limit the scope of the present disclosure. Any modifications, equivalents, improvements, etc. which fall within the spirit and principles of the present disclosure are intended to be included within the scope of the present disclosure.

The system, apparatus, module, or unit set forth in the above embodiments may be embodied by a computer chip or entity or by a product having a certain function. A typical implementation device is a computer. Specifically, the computer may be, for example, a personal computer, a laptop computer, a cellular phone, a camera phone, a smart phone, a personal digital assistant, a media player, a navigation device, an email device, a game console, a tablet computer, a wearable device, or a combination of any of these devices.

Computer-readable media, including permanent and non-permanent, removable and non-removable media, may be implemented for information storage by any method or technique. The information may be computer-readable instructions, data structures, modules of a program, or other data. Examples of storage media for computers include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disc read-only memory (CD-ROM), digital versatile disks (DVD) or other optical storage, magnetic cassette tape, magnetic disk storage or other magnetic storage devices, or any other non-transmission medium that can be used to store information that can be accessed by a computing device. As defined herein, a computer-readable medium does not include a transitory media, such as modulated data signals and carrier waves.

It is also noted that the terms “comprises,” “comprising,” or any other variation thereof, are intended to cover a non-exclusive inclusion, such that a process, method, article, or device that comprises a list of elements includes not only those elements but also other elements not expressly listed, or also includes elements inherent to such process, method, article, or device. Without more limitations, elements defined by the statement “include a . . . ” do not exclude additional identical elements included in the process, method, article, or device including the elements.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A voiceprint recognition method, comprising: by an electronic device,
obtaining a plurality of sets of second voiceprint features respectively corresponding to a plurality of first voiceprint features by, for each of the first voiceprint features, determining ones of voiceprint features in a voiceprint library similar to the each of the first voiceprint features as one of the sets of second voiceprint features;
obtaining a plurality of first correlations for the first voiceprint features by, for every two of the first voiceprint features respectively as a first first voiceprint feature and a second first voiceprint feature, determining a correlation between the first first voiceprint feature and the second first voiceprint feature based on a first set of the sets of second voiceprint features corresponding to the first first voiceprint feature, a first number of second voiceprint features of the first set, a second set of the sets of second voiceprint features corresponding to the second first voiceprint feature, and a second number of second voiceprint features of the second set, as one of the first correlations; and
determining user information for each of the first voiceprint features based on the first correlations and a plurality of first similarities, wherein each of the first similarities represents a similarity between two of the first voiceprint features.

2. The voiceprint recognition method of claim 1, wherein the determining of the ones of the voiceprint features in the voiceprint library similar to the each of the first voiceprint features as the one of the sets of second voiceprint features comprises:
determining a plurality of second similarities respectively corresponding to the voiceprint features in the voiceprint library, wherein each of the second similarities represents a similarity between the each of the first voiceprint features and one of the voiceprint features in the voiceprint library;
determining ones of the voiceprint features in the voiceprint library each having one of the second similarities greater than or equal to a first preset similarity threshold, as a plurality of candidate voiceprint features; and
determining, from the candidate voiceprint features, the ones of the voiceprint features in the voiceprint library similar to the each of the first voiceprint features as the one of the sets of second voiceprint features.

3. The voiceprint recognition method of claim 2, wherein the determining of the ones of the voiceprint features in the voiceprint library similar to the each of the first voiceprint features as the one of the sets of second voiceprint features from the candidate voiceprint features comprises:
determining a plurality of third similarities for the candidate voiceprint features, wherein each of the third similarities represents a similarity between every two of the candidate voiceprint features;
determining a density coefficient for the each of the first voiceprint features based on the third similarities and ones of the second similarities respectively corresponding to the candidate voiceprint features, wherein the density coefficient represents a probability that the each of the first voiceprint features and the candidate voiceprint features belong to a same user; and
in response determining that the density coefficient is greater than or equal to a preset coefficient threshold, determining the candidate voiceprint features as the one of the sets of second voiceprint features.

4. The voiceprint recognition method of claim 3, wherein the determining of the density coefficient for the each of the first voiceprint features comprises:
obtaining a plurality of second correlations respectively corresponding to the candidate voiceprint features by, for each of the candidate voiceprint features, taking one of the second similarities corresponding to the each of the candidate voiceprint features and ones of the third similarities associated with the each of the candidate voiceprint features as a set of similarities and calculating a sum of ones in the set of similarities each being greater than or equal to a second preset similarity threshold as one of the second correlations; and
determining the density coefficient for the each of the first voiceprint features based on the second correlations.

5. The voiceprint recognition method of claim 4, wherein the determining of the density coefficient for the each of the first voiceprint features based on the second correlations comprises:
calculating a sum of the second correlations; and
performing a logarithmic operation on the sum of the second correlations to obtain the density coefficient for the each of the first voiceprint features.

6. The voiceprint recognition method of claim 1, wherein the determining of the correlation between the first first voiceprint feature and the second first voiceprint feature comprises:
determining an intersection of the first set and the second set; and
determining the correlation between the first first voiceprint feature and the second first voiceprint feature based on a number of second voiceprint features of the intersection, the first number and the second number.

7. The voiceprint recognition method of claim 1, wherein the determining of the user information comprises: for the every two of the first voiceprint features respectively as the first first voiceprint feature and the second first voiceprint feature,
labeling the first first voiceprint feature and the second first voiceprint feature with a first label based on the one of the first correlations and one of the first similarities representing the similarity between the first first voiceprint feature and the second first voiceprint feature, wherein the first label indicates whether the first first voiceprint feature and the second first voiceprint feature belong to a same user; and
determining the user information for each of the first first voiceprint feature and the second first voiceprint feature based on the first label.

8. The voiceprint recognition method of claim 7, wherein the labeling of the first first voiceprint feature and the second first voiceprint feature with the first label comprises:
labeling the first first voiceprint feature and the second first voiceprint feature with the first label based on a security level for the first first voiceprint feature and the second first voiceprint feature, the one of the first correlations and the one of the first similarities.

9. The voiceprint recognition method of claim 1, wherein the determining of the user information comprises:
clustering the first voiceprint features based on the first similarities and the first correlations to obtain, for each of the first voiceprint features, a cluster to which the each of the first voiceprint features belongs; and
determining the user information for the each of the first voiceprint features based on the cluster to which the each of the first voiceprint features belongs.

10. The voiceprint recognition method of claim 9, wherein the clustering of the first voiceprint features to obtain the cluster to which the each of the first voiceprint features belongs comprises:
performing a plurality of labeling operations on the first voiceprint features to generate second labels respectively for the first voiceprint features; and
obtaining the cluster to which the each of the first voiceprint features belongs by aggregating ones of the first voiceprint features, for which respective ones of the second labels are identical, into a cluster, and
wherein each of the labeling operations comprises:
selecting an unlabeled one of the first voiceprint features as a target first voiceprint feature;
determining one or more of the first voiceprint features similar to the target first voiceprint feature based on the first similarities, as one or more third first voiceprint features;
determining a cluster center type for the target first voiceprint feature based on ones of the first correlations each representing a correlation between one of the third first voiceprint features and the target first voiceprint feature; and
labeling, based on the cluster center type, the target first voiceprint feature and each unlabeled one of the third first voiceprint features with one of the second labels.

11. The voiceprint recognition method of claim 10, wherein the determining of the cluster center type for the target first voiceprint feature comprises:
determining one or more of the third first voiceprint features as one or more target third first voiceprint features, wherein one of the first correlations between each of the one or more of the third first voiceprint features and the target first voiceprint feature is greater than a preset correlation threshold; and
in response to determining that a number of the target third first voiceprint features is greater than or equal to a preset number threshold, determining the cluster center type to be a type of valid cluster center.

12. The voiceprint recognition method of claim 10, wherein the labeling of the target first voiceprint feature and the each unlabeled one of the third first voiceprint features comprises:
in response to determining that the cluster center type is a type of valid cluster center, creating a new user class;
labeling the target first voiceprint feature with one of the second labels representing the new user class; and
labeling the each unlabeled one of the third first voiceprint features with the one of the second labels representing the new user class.

13. An electronic device, comprising:
a processor;
a memory storing instructions executable by the processor to perform operations comprising:
obtaining a plurality of sets of second voiceprint features respectively corresponding to a plurality of first voiceprint features by, for each of the first voiceprint features, determining ones of voiceprint features in a voiceprint library similar to the each of the first voiceprint features as one of the sets of second voiceprint features;
obtaining a plurality of first correlations for the first voiceprint features by, for every two of the first voiceprint features respectively as a first first voiceprint feature and a second first voiceprint feature, determining a correlation between the first first voiceprint feature and the second first voiceprint feature based on a first set of the sets of second voiceprint features corresponding to the first first voiceprint feature, a first number of second voiceprint features of the first set, a second set of the sets of second voiceprint features corresponding to the second first voiceprint feature, and a second number of second voiceprint features of the second set, as one of the first correlations; and
determining user information for each of the first voiceprint features based on the first correlations and a plurality of first similarities, wherein each of the first similarities represents a similarity between two of the first voiceprint features.

14. The electronic device of claim 13, wherein the determining of the ones of the voiceprint features in the voiceprint library similar to the each of the first voiceprint features as the one of the sets of second voiceprint features comprises:
determining a plurality of second similarities respectively corresponding to the voiceprint features in the voiceprint library, wherein each of the second similarities represents a similarity between the each of the first voiceprint features and one of the voiceprint features in the voiceprint library;
determining ones of the voiceprint features in the voiceprint library each having one of the second similarities greater than or equal to a first preset similarity threshold, as a plurality of candidate voiceprint features; and
determining, from the candidate voiceprint features, the ones of the voiceprint features in the voiceprint library similar to the each of the first voiceprint features as the one of the sets of second voiceprint features.

15. The electronic device of claim 14, wherein the determining of the ones of the voiceprint features in the voiceprint library similar to the each of the first voiceprint features as the one of the sets of second voiceprint features from the candidate voiceprint features comprises:
determining a plurality of third similarities for the candidate voiceprint features, wherein each of the third similarities represents a similarity between every two of the candidate voiceprint features;
determining a density coefficient for the each of the first voiceprint features based on the third similarities and ones of the second similarities respectively corresponding to the candidate voiceprint features, wherein the density coefficient represents a probability that the each of the first voiceprint features and the candidate voiceprint features belong to a same user; and
in response determining that the density coefficient is greater than or equal to a preset coefficient threshold, determining the candidate voiceprint features as the one of the sets of second voiceprint features.

16. The electronic device of claim 15, wherein the determining of the density coefficient for the each of the first voiceprint features comprises:
obtaining a plurality of second correlations respectively corresponding to the candidate voiceprint features by, for each of the candidate voiceprint features, taking one of the second similarities corresponding to the each of the candidate voiceprint features and ones of the third similarities associated with the each of the candidate voiceprint features as a set of similarities and calculating a sum of ones in the set of similarities each being greater than or equal to a second preset similarity threshold as one of the second correlations; and
determining the density coefficient for the each of the first voiceprint features based on the second correlations.

17. The electronic device of claim 16, wherein the determining of the density coefficient for the each of the first voiceprint features based on the second correlations comprises:
calculating a sum of the second correlations; and
performing a logarithmic operation on the sum of the second correlations to obtain the density coefficient for the each of the first voiceprint features.

18. The electronic device of claim 13, wherein the determining of the correlation between the first first voiceprint feature and the second first voiceprint feature comprises:
determining an intersection of the first set and the second set; and
determining the correlation between the first first voiceprint feature and the second first voiceprint feature based on a number of second voiceprint features of the intersection, the first number and the second number.

19. A non-transitory computer-readable storage medium storing instructions executable by a processor of an electronic device to perform operations comprising:
obtaining a plurality of sets of second voiceprint features respectively corresponding to a plurality of first voiceprint features by, for each of the first voiceprint features, determining ones of voiceprint features in a voiceprint library similar to the each of the first voiceprint features as one of the sets of second voiceprint features;
obtaining a plurality of first correlations for the first voiceprint features by, for every two of the first voiceprint features respectively as a first first voiceprint feature and a second first voiceprint feature, determining a correlation between the first first voiceprint feature and the second first voiceprint feature based on a first set of the sets of second voiceprint features corresponding to the first first voiceprint feature, a first number of second voiceprint features of the first set, a second set of the sets of second voiceprint features corresponding to the second first voiceprint feature, and a second number of second voiceprint features of the second set, as one of the first correlations; and
determining user information for each of the first voiceprint features based on the first correlations and a plurality of first similarities, wherein each of the first similarities represents a similarity between two of the first voiceprint features.

20. A computer program product, comprising a non-transitory computer-readable storage medium storing a computer program executable by a computer to perform the voiceprint recognition method of claim 1.
